(19) United States
(12) Patent Application Publication
(10) Pub. No.: US 2017/0046717 A1
(43) Pub. Date: Feb. 16, 2017

(54) DATABASE SYSTEMS AND USER INTERFACES FOR DYNAMIC INTERACTION WITH, AND COMPARISON OF, CUSTOMER DATA

(71) Applicant: Gary S. Davi, Laguna Beach, CA (US)

(72) Inventor: Gary S. Davi, Laguna Beach, CA (US)

(21) Appl. No.: 15/234,979

(22) Filed: Aug. 11, 2016

Related U.S. Application Data
(60) Provisional application No. 62/203,648, filed on Aug. 11, 2015.

(51) Int. Cl. G06Q 30/00; G06Q 10/10; G06F 3/0482; G06F 17/30

(52) U.S. Cl. CPC G06Q 30/01; G06F 17/30061; G06F 17/30241; G06Q 10/1095; G06F 3/0482

(57) ABSTRACT

Systems and techniques are disclosed for an interactive information map systems that enables a user to more quickly, thoroughly, and efficiently aggregate information from one or more sets of customer databases, extrapolate important information from the one or more databases about customers in a geographic location, provide real-time information gathered from customer data, and allow the user to interact with customer data.

### INCORPORATION BY REFERENCE TO ANY PRIORITY APPLICATIONS

This application claims priority benefit of U.S. Provisional Application No. 62/203,648, filed Aug. 11, 2015. Any and all applications for which a foreign or domestic priority claim is identified in the Application Data Sheet as filed with the present application are hereby incorporated by reference under 37 CFR 1.57.

### TECHNICAL FIELD

Embodiments of the present disclosure relate to systems and techniques for accessing one or more databases in substantially real-time to provide a user interface for dynamic interactions with customer data. More specifically, embodiments of the present disclosure relate to user interfaces for dynamically providing a visual representation of information generated by aggregating customer data from one or more databases and extrapolating useful information.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Geographical map applications (for example, Geographical Information Systems (GIS)) generally have graphical user interfaces that include map images overlaid by various objects and geographical data, for example in some embodiments, the geographical data may comprise data representing roads, buildings, etc. In some embodiments, the map images may comprise satellite images. An application may further be able to aggregate real-time information gathered from one or more information databases and display the information in an interactive manner that provides the user with insightful information.

### SUMMARY

The systems, methods, and devices described herein each have several aspects, no single one of which is solely responsible for its desirable attributes. Without limiting the scope of this disclosure, several non-limiting features will now be described briefly.

Embodiments of the present disclosure relate to an interactive information map system (also referred to herein as “the system”) and techniques for accessing data stores of customer data, extrapolating important information from the customer data, and displaying visual representations of the customer data to enable a user to efficiently obtain information in an interactive user interface. Previous systems for display of, and interaction with, customer data were typically inefficient at enabling the user to extrapolate important information about the customer in a geographical location. The previous mapping systems were limited to providing a customer's geographical location as a pushpin with basic hover over information. Disclosed herein are systems that, according to various embodiments, advantageously provide highly efficient, intuitive, and rapid dynamic interaction with customers and customer data (including sales lists, potential leads, contact information, and other information) to enable the user to extrapolate important information about the customer in a geographical location. The systems may include interactive user interfaces that are dynamically updated to provide rapid comparison of multiple customers. Further, customer information may be automatically sorted for example in some embodiments, by the system according to attributes associated with the customer and rules and/or preferences of the user.

Systems and methods are disclosed for providing a cloud based location intelligence and instructions systems. The system provides real-time location intelligence on a user interface. The user interface may comprise a map of customer information and activity at the contact level. The user may select a customer from the user interface, and the system automatically retrieves and provides the user with important information about the customer gathered from one or more separate customer databases. Accordingly, a user may use the systems described herein to more quickly, thoroughly, and efficiently interact with multiple customer information, as compared to previous systems. The features and advantages noted above, as well as others, are discussed in further detail below.

In various embodiments, the system creates a complete picture of the customers, including for example, the customer's segments, influencers and competitors. The system combines insights from social channels and campaigns with web analytics and transactional data. In some embodiments, the system utilizes small data to build efficient and user-friendly profiles.

In various embodiments, systems and methods are disclosed for aggregating multiple separate customer information databases, or data points, and extrapolating important information about the customer in a geographic location. In one example, the system provides color coded leads, including warnings and other information. The other information may comprise whether the customer has participated in certain events or meetings. The warnings may alert the user to situations in which a period of inactivity relating to customer contact has exceeded a predetermined number of days.

In various embodiments, system and methods are disclosed for categorizing the customers based on the aggregated customer information. The categories may include cold leads, warms lead, or hot leads. The system may automatically identify a customer as one with particular interest to the user based on the categorization and provide the user with a visual representation indicating the customer's status. The user may then select and interact with the customer.

Accordingly, in various embodiments, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs. Furthermore, in some embodiments, the system may aggregate large amounts of data from one or more customer databases.

Further, as described herein, the system may be configured and/or designed to generate user interface data useable for rendering the various interactive user interfaces described. The user interface data may be used by the system, and/or another computer system, device, and/or software program (for example, a browser program) to render the interactive user interfaces. The interactive user interfaces may be displayed on, for example, electronic displays (including, for example, touch-enabled displays).

It has been noted that design of computer user interfaces “that are useable and easily learned by humans is a non-trivial problem for software developers.” (Dillon, A. (2003) User Interface Design. MacMillan Encyclopedia of Cognitive Science, Vol. 4, London: MacMillan, 453-458.) The present disclosure describes various embodiments of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface including interactions with mapped customer data, among other interactions described herein may provide optimized interactions in comparison to previous systems.

Various embodiments of the present disclosure provide improvements to various technologies and technological fields. For example, existing geographical map application technology, as described above, is limited in various ways, and various embodiments of the disclosure provide significant improvements over such technology. For example, existing geographical map application technology is limited since the amount of customer information provided is minimal, the customer data that is provided may not be presented efficiently or at all, and interactions between the customer and the user is limited or not provided at all. Additionally, various embodiments of the present disclosure are inextricably tied to computer technology. In particular, various embodiments rely on aggregation of customer data, extrapolating important information about a customer in a geographical location, displaying such data in interactive graphical user interfaces displayed on electronic displays, etc. In some embodiments, customer data may include sales lists, potential leads, contact information, and other information. Such features are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above- and/or below-described embodiments (including one or more aspects of the appended claims).

In various embodiments, computer-implemented methods are disclosed in which, by one or more processors executing program instructions, one or more aspects of the above- and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above- and/or below-described embodiments (including one or more aspects of the appended claims).

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 illustrates an example graphical user interface of an interactive information map system, according to an embodiment of the present disclosure.

FIG. 2 illustrates an example legend located on a user interface of the interactive information map system in which various types of data icons are displayed, according to embodiments of the present disclosure.

FIG. 3 shows a flowchart depicting an illustrative operation of the interactive information map system, according to an embodiment of the present disclosure.

FIG. 4A illustrates an example network environment in which various methods and systems discussed herein may be implemented, according to an embodiment of the present disclosure.

FIG. 4B illustrates example computer systems and devices on which various methods and systems discussed herein may be implemented, according to various embodiments of the present disclosure.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. The structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### I. Overview

According to various embodiments an interactive information map system (also referred to herein as “the system”) is disclosed that enables a user to more quickly, thoroughly, and efficiently aggregate information from one or more sets of customer databases, extrapolate important information from the one or more databases about customers in a geographic location, provide real-time information gathered from customer data, and allow the user to interact with the customer data or directly with the customer. This and other functionality and advantages are provided, according to various embodiments, via interactive graphical user interfaces, including interactive map interfaces, which are inextricably tied to computer technology.

As also mentioned above, the system enables a user to efficiently search through, and determine matches within, large amounts of data including customer data. The interactive information map system may include an interactive user interface in which customer data may be displayed on a map.

In various embodiments, the system creates a complete picture of customer data, including for example, the customer's segments, influencers and competitors. The system combines insights from social channels and campaigns with web analytics and transactional data. In some embodiments, the system may utilize advanced customer relationship management (CRM) techniques to utilize small data in building efficient and user-friendly profiles.

In some embodiments, the system may generate alerts that may be automatically transmitted to a mobile device of the user, and may activate an application on the mobile device of the user, to provide timely notifications to the user, for example, of prolonged periods of customer inactivity.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

### II. Terms

In order to facilitate an understanding of the systems and methods discussed herein, a number of terms are defined below. The terms defined below, as well as other terms used herein, should be construed broadly to include the provided definitions, the ordinary and customary meaning of the terms, and/or any other implied meaning for the respective terms. Thus, the definitions below do not limit the meaning of these terms, but only provide exemplary definitions.

Database: A broad term that includes, but is not limited to only, a data structure identified as a database, for example, RDBMS, or SQL, or NoSQL databases. Rather, a “database” may refer to any other data store or data structure such as, for example, comma separated values (CSV) files, extendible markup language (XML) files, text (TXT) files, flat files, spreadsheet files, and/or any other widely used or proprietary format.

Customer Data: Any type of data and/or information related to customers. Also referred to herein as customer data items. A customer data item generally includes at least a geographical location associated with a customer. A customer data item generally also includes a unique identifier. The location may be specified by, for example in some embodiments, an address, latitude and longitude, Global Positioning System (GPS) coordinates, other global coordinates, other location formats, and/or the like. The location may be highly specific such that a small geographic area is encompassed by the location, or more general such that a larger geographic area is encompassed by the location. In some embodiments in which the location is highly specific, the location may comprise a particular address and/or narrowly defined GPS coordinates. Alternatively, in some embodiments in which the location is more general, the location may comprise a street and/or broadly defined GPS coordinates. In some instances customer data may include other information, for example in some embodiments, the customer data may comprise a description of the customer, customer sales lists, potential customer leads, customer contact information, and other customer information. Any combination of different types of customer data items may be used in the system simultaneously. Customer data items may be from various sources, and may be associated with various types of customers. Customer data may be obtained from a single database or multiple databases. The single and/or multiple databases from which customer data may be obtained may be operated, maintained, and/or owned by various entities.

### III. Map System and Customer Data Analysis

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

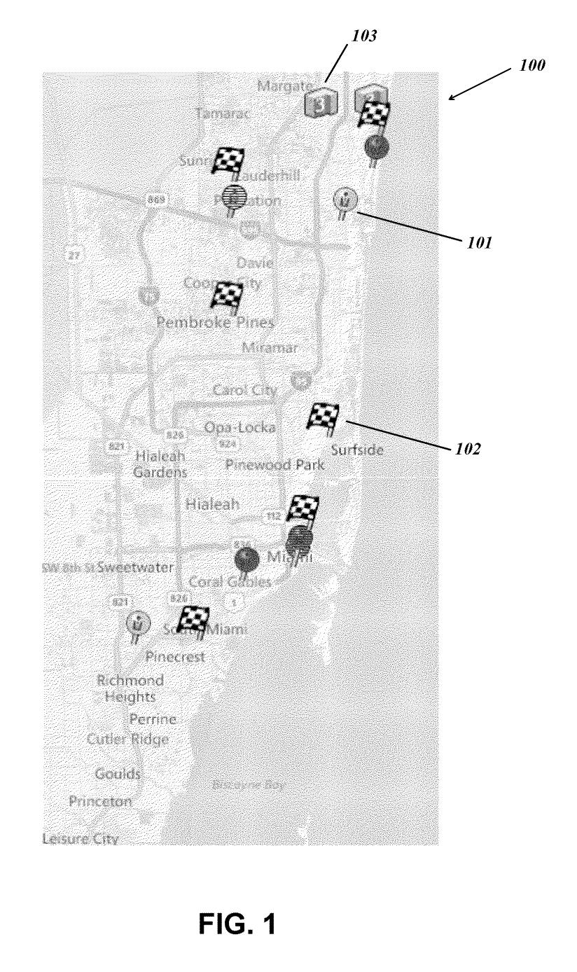

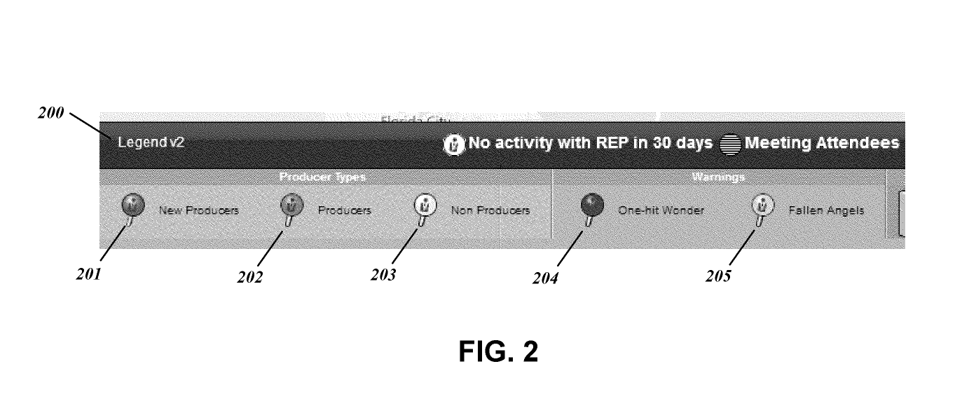

FIGS. 1 and 2 illustrate an example graphical user interface of the interactive information map system, according to an embodiment of the present disclosure. The system generates valuable customer information by aggregating information from one or more customer databases and extrapolating important information relevant to the user about potential customers in a geographic location. In various embodiments, the system displays each customer data item on the map interface 100 through a particular visual representation. The visual representation is capable of quickly and efficiently providing the user with valuable customer information. The system assigns the particular representation to the customer data item based on customer information extrapolated from sales information and other activities related to the customer. The system may also gather information relating to whether a customer is a new customer, current active customer, a former customer, a customer with a prolonged period of inactivity, or a customer with a single purchase. The visual representations of the customer data items may also be animated to show, among other things, recent activity, such as a new purchase order, recent contact, etc.

In some embodiments, the system utilizes a graphical user interface to display visual representations that provide the user with insightful information about the customer. The particular visual representation distinguishes the system from previous interfaces that are limited to showing the customer's geographic location. In some embodiments, the system displays a visual representation that provides the user with information relating to the customer activity, sales information, or customer phone number, among other information, without the user having to go back to the one or more customer database(s).

The system enables a user to collate customer information stored across one or more customer databases and use a visual representation to quickly and easily obtain useful information. The system extrapolates important information relevant to the user about potential customers in a geographic location by allowing the user to set up configuration objects that provide the requisite underlying information. The system collectively processes the configuration objects to provide the particular visual representation.

In some embodiments, the system may characterize a customer data item into various producer classifications: “New producer,” “High Performing Producer,” “New Producer with No Interactions,” “High Performing Producer with No Interactions,” “Campaign Attendee,” and “Non-Producers.” The system may classify a customer as a “New Producer” if the customer made a first sale or purchase within the last 90 days. The system may classify a customer as a “High Performing Producer” if the customer averages two sales per month in the last 12 months with a combined amount greater than a predetermined amount of money. In some embodiments, the predetermined amount of money for a “High Performing Producer” may be $48,000. The system may classify a customer as a “New Producer with No Interactions” if the customer satisfies the requirements of a “New Producer,” and the account manager for the customer has not been met with or contacted within the last 30 days. In some embodiments, the classification of a “New Producer with No Interactions” may initiate a warning or alert to the user relating to the customer. The system may classify a customer as a “High Performing Producer with No Interactions” if the customer satisfies the requirements of a “High Performing Producer,” and the account manager for the customer has not been met with or contacted within the last 30 days. In some embodiments, the classification of a “High Performing Producer with No Interactions” may initiate a warning or alert to the user relating to the customer. The system may classify a customer as a “Campaign Attendee” if the customer attended a campaign or an event but has not contributed to the sale of the business. The system may classify a customer as a “Non-Producer” if the customer is a potential customer that has not sold. The system may display customers with various producer classifications by using particular visual representations to enable to the user to quickly obtain a report with desired, specific, accurate and real-time information.

In various embodiments, the system creates a complete picture of customer data, including for example, the customer's segments, influencers and competitors. The system combines insights from social channels and campaigns with web analytics and transactional data. In some embodiments, the system may incorporate advanced customer relationship management (CRM) techniques to utilize small data in building efficient and user-friendly profiles. Previous systems for display of, and interaction with, customer data were typically inefficient at managing large amounts of back end data to enable the user to extrapolate important information about the customer in a geographical location. The previous mapping systems were limited to providing a customer's geographical location as a pushpin with basic hover over information. In some embodiments, the current system improves upon the functioning of previous systems and increases user efficiency by granting the user access to data on the front end through the user interface to otherwise manage and access back end data.

In various embodiments, special security configurations may be implemented to govern the specific customer data items accessible by specific groups of users. In some embodiments, customer information can be tracked by individual users or by the user company base to track the progress and success of the individual users.

In various embodiments, visual representation logic (VRL) is implemented. VRL allows customers to configure how the system can collate the customer data across multiple customer data bases and generates valuable customer information. The customer may configure the particular visual representation for a specific department that wishes to utilize the visual representation.

In some embodiments, additional system intelligence enables the customers to set up action that can be performed directly through the visual representations by the user. For example, a customer may permit a user to book a meeting, add the customer data item to a “plan visits” list, or export the customer data item to excel through user interaction with the visual representation. The additional actions allow the user to interact directly with the customer through the user interface. For example, the interface allows the user to schedule a meeting directly from the system, and the system may then sync back any related user activity to the main customer database.

### IV. Example User Interface and Computing Devices and Systems

As described, FIGS. 1 and 2 illustrate an example graphical user interface of the interactive information map system, according to an embodiment of the present disclosure. The user interface may include a map interface 100 and a legend 200. Various data items, including customer data, may be represented on the map interface 100 with icons and/or symbols, as displayed within the legend 200. FIG. 2 illustrates several examples of icons 201-205 that may represent customer data on the map interface 100. For example, icon 201 represents a customer classified as a “New Producer” located at the geographical location on the map interface 100. Additionally, icons 202 and 203 may represent customers classified as a “Producer” or “Non-Producer,” respectively. The user may select and/or otherwise interact with customer data for each customer displayed on the map interface 100.

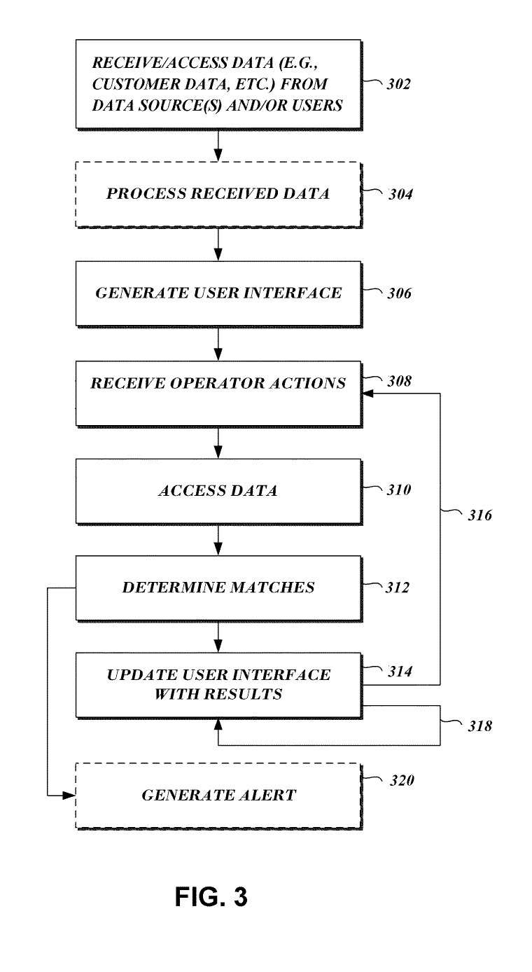

In various embodiments, functionality of the interactive information map system (as described in reference to the various figures below) may be implemented in one or more computer modules and/or processors, as is described below with reference to FIGS. 3A-3C.

In various embodiments, the user interface of FIG. 1 is displayed on an electronic display viewable by a user of the interactive information map system. The user of the interactive information map system may interact with the user interface of FIG. 1 by, for example, touching the display when the display is touch-enabled, using a mouse pointer to click on the various elements of the user interface, and/or using a keyboard to input data.

The user of the system may interact with the user interface (as shown in FIG. 1) by scrolling or panning up, down, and/or side to side; zooming in or out; selecting data items; drawing shapes; performing a search queries; and/or the like. Various user actions may reveal more or less map detail, and/or more or fewer data items.

FIG. 1 illustrates an example user interface of the interactive information map system in which various types of customer data items are displayed, according to embodiments of the present disclosure. Several sets of customer data items have been imported into the system. Customer data items include, for example, sales lists, potential leads, contact information, customer types, and warnings. The user may select one or more of the customer data items displayed to cause the system to display, in the map interface 100, additional customer details.

In various embodiments, the system provides color coded representations. As shown in the map interface 100, various customer data items are represented by a color-coded push-pin icon 101, a checkered flag 102, or other icons, such as symbol 103. Each push-pin icon may represent a customer type associated with a customer data item, such as “Producer Type” or “Warning” shown in the legend 200 in FIG. 2. The “Warning” icons may include, for examples, the customer's attendance at the user's conference or a period of inactivity exceeding a predetermined number of days. In some embodiments, the icons may be flashings to indicate a warning. The user may then select, via the map interface 100, the icon to view further details.

The system can be implemented in software running on a server, computer, laptop, tablet, phone or other electronic device and is designed to operate within sales information platform, such as, for example, Salesforce. Some platforms require that the system be designed and implemented via metadata alone. However, the technical challenge in these types of environments is to design the individual objects and processes that would support the type of inferences to be made for the user using the desired platform.

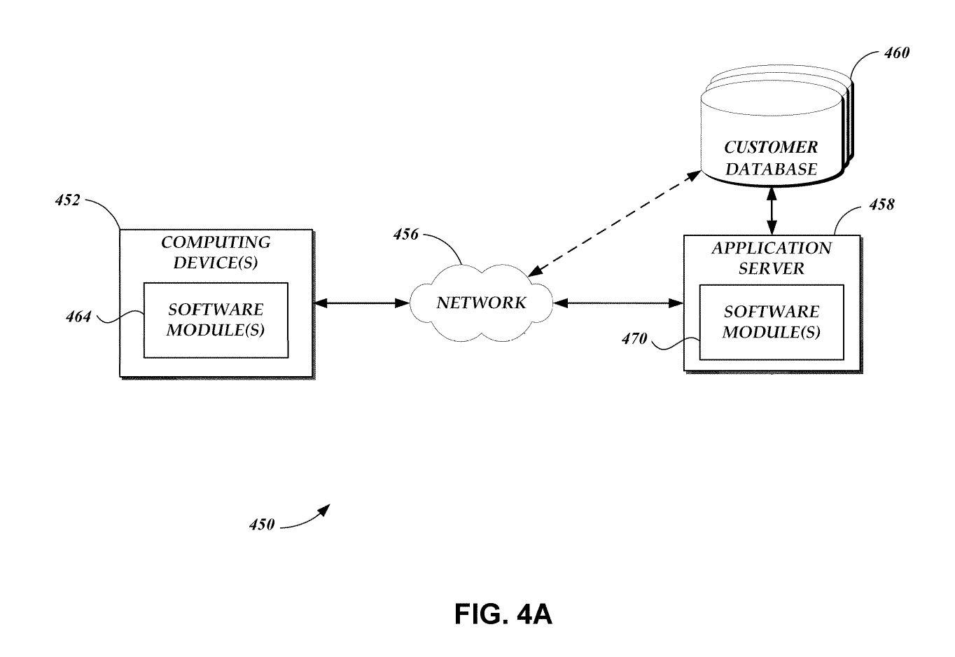

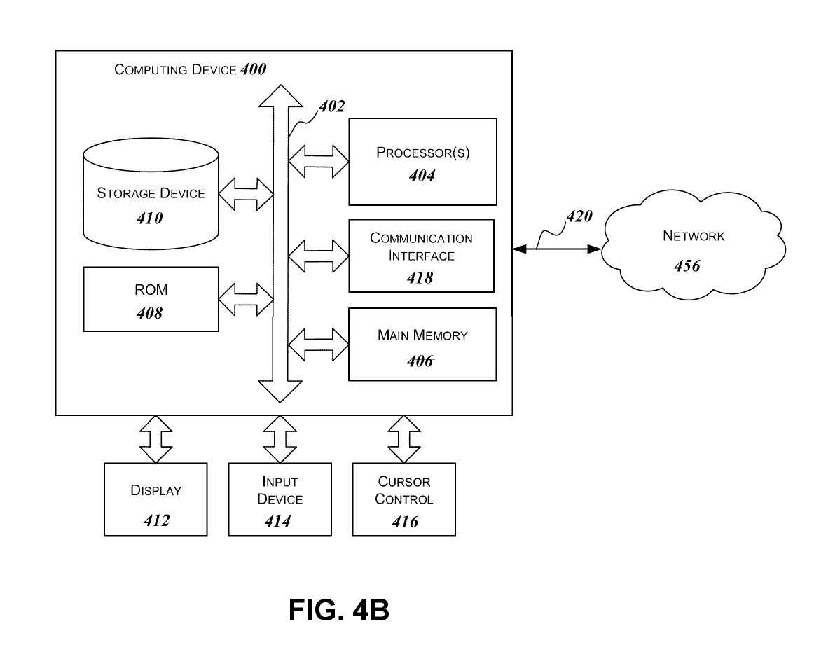

FIG. 3 shows a flowchart depicting an illustrative operation of the interactive information map system, according to an embodiment of the present disclosure. In various embodiments, fewer blocks or additional blocks may be included in the processes, or various blocks may be performed in an order different from that shown in FIG. 3. In an embodiment, one or more blocks in FIG. 3 may be performed by, or implemented in, one or more computer modules and/or processors, as is described below with reference to FIGS. 4A and 4B.

At block 302, various customer data may be received and/or accessed by the system from one or more databases and/or data sources (including, for example, from databases maintained by the user or third party entities). In an embodiment, the customer data may be received at a server-side component of the system, such as the application server 458 of FIG. 4A. The data may then optionally be processed by the server at block 304. For example, the customer data may be organized by location, time, type, and/or by any other useful index so as to enable fast searching of the data. At block 306, a user interface (and/or user interface data) is generated that displays (and/or is useable to generate and display) a user interface, as described with reference to the figures above and below. For example, a map interface may be displayed on the user interface.

At block 308, the user may interact with the user interface of the system in any of the ways described above, and as further described below. For example, the user may import data, interact with the map interface, provide various search query criteria, etc. At block 310, the processed customer data may be accessed by the system based on the provided user actions, and, at block 712, data satisfying the provided user actions may be determined and/or identified.

In various embodiments, the map system may access one or more internal and/or external databases in response to user actions. The one or more accessed internal and/or external databases may or may not include the processed customer data described above.

At block 314, the user interface may be updated in response to the user's actions. For example, additional customer information may be displayed in lists and/or in the map interface, and/or animations may be provided, among other interface updates described above. As indicated by arrow 316, the operation may continue to block 308 such that the user may update and/or input a new action. Alternatively, as indicated by arrow 318, the operation may continue to update the user interface and the user interacts with the system in any of the various ways described here.

In various embodiments, customer data may be received and processed by the system at any time and/or continuously. In an embodiment, customer data may be updated even as the user is viewing the data on the user interface. For example, in an embodiment, the user may use the system to analyze substantially real-time customer data.

At optional block 320, the system may generate alerts to the user. Alerts may comprise electronic notifications of changes and/or updates, for example, related to a user's actions. For example, as customer data is updated in the system, the system may determine new or different customer classification, or may determine that user interfaces are or would be updated as a result of the updates. Accordingly, in order that the user may be made aware of these changes in a timely manner, an alert and/or notification may be automatically transmitted, for example, to a mobile device (or other device) operated by the user. The alert and/or notification can be transmitted at the time that the alert and/or notification is generated or at some determined time after generation of the alert and/or notification. When received by the device, the alert and/or notification can cause the device to display the alert and/or notification via the activation of an application on the device. In some embodiments, the device may comprise a browser, a mobile application, etc. For example, receipt of the alert and/or notification may automatically activate an application on the device, such as a messaging application, a standalone application, or a browser, for example, and display information included in the alert and/or notification. In some embodiments, the messaging application may comprise a SMS or MMS messaging application. In an alternative embodiment, the standalone application may comprise an interactive information map system application. If the device is offline when the alert and/or notification is transmitted, the application may be automatically activated when the device is online such that the alert and/or notification is displayed. As another example, receipt of the alert and/or notification may cause a browser to open and be redirected to a login page generated by the interactive information map system so that the user can log in to the interactive information map system and view the alert and/or notification. Alternatively, the alert and/or notification may include a URL of a webpage (or other online information) associated with the alert and/or notification, such that when the device receives the alert, a browser (or other application) is automatically activated and the URL included in the alert and/or notification is accessed via the Internet.

### V. Implementation Mechanisms

FIG. 4A illustrates a network environment in which the interactive information map system may operate, according to embodiments of the present disclosure. The network environment 450 may include one or more computing devices 452, a network 456, an application server 458, and one or more data sources 460. In some embodiments, the one or more data sources may comprise a customer database 460. The constituents of the network environment 450 may be in communication with each other either locally or over the network 456.

In an embodiment, the computing device(s) 452 may be any computing devices capable of displaying software applications to a user and receiving input from the user. For example, the computing device(s) 452 may include smartphones, tablets, laptops, and/or other types of computing devices. The computing device(s) 452 may also be capable of communicating over the network 456, for example, to request data from, and/or to data to, the application server 458.

In some embodiments, the computing device(s) 452 may include non-transitory computer-readable medium storage for storing customer data and/or other map application data. For example, computing device(s) 452 may include one or more software modules 464 that may implement aspects of the functionality of the interactive information map system. The software module(s) 464 may be configured to present the map application to a user and receive interactions from the user. Additional aspects, operations, and/or functionality of computing device(s) 452 are described in further detail in reference to FIG. 4B above and below.

The network 456 may be any wired network, wireless network, or combination thereof. In addition, the network 456 may be a personal area network, local area network, wide area network, cable network, satellite network, cellular telephone network, or combination thereof. Protocols and components for communicating via the Internet or any of the other aforementioned types of communication networks are well known to those skilled in the art of computer communications and thus, need not be described in more detail herein.

The application server 458 is a computing device, similar to the computing devices described above, that may perform a variety of tasks to implement the operations of the interactive information map system. The application server 458 may include one or more software modules 470 that may be configured to, for example, receive customer data, process the received data, generate user interfaces and/or user interface data, process inputs from the user, and/or update the user interface. Additional aspects, operations, and/or functionality of application server 458 are described in further detail in reference to FIG. 4B above and below.

The application server 458 may be in communication with the customer database 460. The customer database 460 may include electronic storage local to the application server 458. The customer database 460 may be embodied in hard disk drives, solid state memories, and/or any other type of non-transitory, computer-readable storage medium remotely or locally accessible to the application server 458. The customer database 460 may also be distributed or partitioned across multiple storage devices, and/or may be combined into a single database, as is known in the art without departing from the spirit and scope of the present disclosure. As indicated by the dashed arrows of FIG. 4A, the customer database 460 may alternatively, or in addition, be in communication with the application server 458 and/or the computing device(s) 452 via the network 456.

In various embodiments, the system may be accessible by the user through a web-based viewer, such as a web browser. In this embodiment, the user interface may be generated by the application server 458 and transmitted to the web browser of the user. Alternatively, data necessary for generating the user interface may be provided by the application server 458 to the browser, where the user interface may be generated. The user may then interact with the user interface through the web-browser. In an embodiment, the user interface of the interactive information map system may be accessible through a dedicated software application. In an embodiment, the user interface of the interactive information map system may be accessible through a mobile computing device, such as a smartphone and/or tablet. In this embodiment, the application server 458 may generate and transmit a user interface to the mobile computing device. Alternatively, the mobile computing device may include modules for generating the user interface, and the application server 458 may provide user interface data to the mobile computing device. In an embodiment, the application server 458 comprises a mobile computing device.

According to various embodiments, the interactive information map system and other methods and techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 4B is a block diagram that illustrates a computing device 400 upon which the various systems, devices, and/or methods discussed herein may be implemented. For example, some or all aspects of computing system 400 may be included in any of computing device(s) 452 and/or application server 458. In an embodiment, each of the computing device(s) 452 and application server 458 is comprised of a computing system similar to the computing device 400 of FIG. 4B. Computing device 400 includes a bus 402 or other communication mechanism for communicating information, and a hardware processor, or multiple processors, 404 coupled with bus 402 for processing information. Hardware processor(s) 404 may be, for example, one or more general purpose microprocessors.

Computing device 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computing device 400 into a special-purpose machine that is customized to perform the operations specified in the instructions.

Computing device 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

Computing device 400 may be coupled via bus 402 to a display 412, such as a cathode ray tube (CRT), LCD display, and/or other electronic or computer display (which, in some embodiments, may be touch sensitive) for displaying information to a computer user and/or receiving input from the user or operator. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis and a second axis, that allows the device to specify positions in a plane. In some embodiments, the first axis may comprise an x axis and the second axis may comprise a y axis. In some embodiments, the same direction information and command selections as cursor control may be implemented via receiving touches on a touch screen without a cursor.

Computing device 400 may include modules configured to generate a user interface, map interface, and/or the various other aspects of the interactive information map system. These modules may include, for example, software module(s) 464 and/or software module(s) 470 described above, among others. The modules may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage

Computing device 400 may implement the techniques described herein using customized hard-wired logic, one or more ASICs or FPGAs, firmware and/or program logic which in combination with the computer system causes or programs computing device 400 to be a special-purpose machine. According to one embodiment, the techniques herein are performed by computing device 400 in response to processor(s) 404 executing one or more sequences of one or more modules and/or instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between nontransitory media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions and/or modules into its dynamic memory and send the instructions over a telephone line using a modem. A modem local to computing device 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computing device 400 also includes a communication interface 418 coupled to bus 402. Communication interface 418 provides a two-way data communication coupling to a network link 420 that may be connected to any other interface and/or network, for example network 456 of FIG. 4A. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN (or WAN component to communicate with a WAN). Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through one or more local or non-local networks to host computers or other data equipment operated by an Internet Service Provider (ISP).

In an embodiment, the network link 420 may provide data communication services through the world wide packet data communication network now commonly referred to as the “Internet.” Communication may be accomplished through the user of, for example, electrical, electromagnetic, and/or optical signals that carry digital data streams. The signals through the various networks and the signals on network link 420 and through communication interface 418, which carry the digital data to and from computing device 400, are example forms of transmission media.

Computing device 400 may send messages and/or receive data, including program code, through the network(s), network link 420 and communication interface 418. In the Internet example, a server or other computer-enabled device or system may transmit a requested code for an application program through one or more networks and/or communication interface 418.

### VI. Additional Embodiments

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A system comprising:
a computer readable storage medium having program instructions embodied therewith; and
one or more processors configured to execute the program instructions to cause the one or more processors to:
aggregate, from one or more data sources, a plurality of customer data records;
extract, from the customer data records, customer data record items; and
generate user interface data for rendering an interactive user interface on an electronic display, the interactive user interface including:
an interactive map, and
a visual representation of a customer data record item,
wherein, each visual representation comprising a marker on the interactive map at the respective customer geographic location associated with the customer data item, and
wherein, each visual representation is configured to provide a user with information relating to the customer item.

2. The system of claim 1, wherein the one or more data sources comprises at least one of:
a user data source; and
a third party data source.

3. The system of claim 1, wherein the customer data record item comprises a customer geographic location.

4. The system of claim 3, wherein the customer geographic location indicates GPS coordinates.

5. The system of claim 1, wherein the customer data record item comprises a customer interaction list.

6. The system of claim 5, wherein the customer interaction list indicates an interaction time and an interaction event.

7. The system of claim 1, wherein the customer data record item comprises one or more sales lists.

8. The system of claim 7, wherein the one or more sales lists indicates a sale time and a sale amount.

9. The system of claim 1, wherein the customer data record item comprises a customer contact information.

10. The system of claim 1, wherein the one or more processors further configured to execute the program instructions to cause the one or more processors to receive an input from the user of the system.

11. The system of claim 10, wherein the input from the user of the system includes meeting criteria comprising at least one of:
a meeting time; and
a meeting location.

12. The system of claim 11, wherein the one or more processors in response to the user input:
generate a meeting request that satisfies the meeting criteria;
update the one or more data sources with the meeting request;
send a message to a customer comprising the meeting criteria; and
update the user interface data such that the interactive user interface includes an indication of the meeting request.

13. The system of claim 10, wherein the input from the user of the system includes export criteria comprising at least one of:
an export content;
an export format; and
an export location.

14. The system of claim 13, wherein the one or more processors in response to the user input:
extract, from the customer data records, customer data export items relating to the export content;
generate an export document comprising the export format and the customer data export items;
store the export document at the export location; and
update the user interface data such that the interactive user interface includes an indication of the export request.

15. The system of claim 10, wherein the input from the user of the system includes future notification criteria comprising at least one of:
a notification time; and
a notification content.

16. The system of claim 15, wherein the one or more processors in response to the user input:
generate a notification request that satisfies the notification criteria;
update the one or more data sources with the notification request; and
update the user interface data such that the interactive user interface includes an indication of the notification request.

17. The system of claim 1, wherein the interactive user interface further comprises a legend.

18. (canceled)

19. The system of claim 18, wherein the visual representation is configured to indicate a warning to the user.

20. A computer-implemented method comprising:
by one or more processors executing program instructions:
aggregating, from one or more data sources, a plurality of customer data records;
extracting, from the customer data records, customer data record items; and
generating user interface data for rendering an interactive user interface on an electronic display, the interactive user interface including:
an interactive map, and
a visual representation of a customer data record item,
wherein, each visual representation comprising a marker on the interactive map at the respective customer geographic location associated with the customer data item, and
wherein, each visual representation is configured to provide a user with information relating to the customer item.

21-38. (canceled)

39. A computer program product for interaction with customer data, the computer program product comprising a computer readable storage medium having program instructions embodied therewith, the program instructions executable by one or more processors to cause the one or more processors to:
aggregate, from one or more data sources, a plurality of customer data records;
extract, from the customer data records, customer data record items, each of the customer data record items; and
generate user interface data for rendering an interactive user interface on an electronic display, the interactive user interface including:
an interactive map, and
a visual representation of a customer data record item,
wherein, each visual representation comprising a marker on the interactive map at the respective customer geographic location associated with the customer data item, and
wherein, each visual representation is configured to provide a user with information relating to the customer item.

40-57. (canceled)
